(19) United States
(12) Patent Application Publication
(10) Pub. No.: US 2019/0218710 A1
(43) Pub. Date: Jul. 18, 2019

(54) Composite Fiber Antibacterial Fabric with Fiber Copper Alloy Wires

(71) Applicant: Yuang Hsian Metal Industrial Corp., Changhua City (TW)

(72) Inventor: Kuo-Ta Chang, Changhua City (TW)

(21) Appl. No.: 15/870,921

(22) Filed: Jan. 13, 2018

(51) Int. Cl. D06M 16/00; D03D 23/00; A01N 25/08; D03D 15/00

(52) U.S. Cl. CPC D06M 16/00; D03D 15/00; A01N 25/08; D03D 23/00

(57) ABSTRACT

A composite fiber antibacterial fabric includes an antibacterial fabric body including multiple composite lines and multiple elastic fiber lines interweaving longitudinally and latitudinally. Each of the composite lines includes multiple multi-filament polyester fiber yarns and at least one or more than one fiber copper alloy wire blending and intertwining with the multi-filament polyester fiber yarns. The at least one or more than one fiber copper alloy wire has a filament shape with a determined flexibility. The at least one or more than one fiber copper alloy wire is oxidized to steadily release copper ions which act in the multi-filament polyester fiber yarns, so that each of the composite lines has an antibacterial function.

### BACKGROUND OF THE INVENTION

### 1. Field of the Invention

The present invention relates to a fabric and, more particularly, to a composite fiber antibacterial fabric with fiber copper alloy wires.

### 2. Description of the Related Art

A conventional antibacterial cloth structure comprises multiple artificial fiber yarns, and a chemical antibacterial agent applied on the artificial fiber yarns. However, the antibacterial function is reduced gradually after frequent cleaning of the cloth structure, thereby decreasing the antibacterial effect of the cloth structure. Another conventional antibacterial cloth structure comprises a silver-contained antibacterial fiber fabric. However, the silver ions permeate through the skin into the human body, so that the heavy metal is accumulated in the human body, thereby causing danger to the user during a long-term utilization. Thus, a copper-contained antibacterial fiber fabric is used to replace the silver-contained antibacterial fiber fabric. The copper-contained antibacterial fiber fabric includes a copper ion fiber that has a great antibacterial feature to refrain the growth of bacteria and to reduce smells or stinks. In addition, the copper ion fiber has a hydrophilic feature to perform neutralization with ammonia, isovaleric acid and acetic acid, to eliminate odors. However, the surface of the copper ion fiber contains a copper compound (or metal salt) that is dissolvable and has a poor acid resistance, so that the copper ions are released and infiltrate through the skin into the human body, and then are metabolized and drained outward from the human body. In addition, the antibacterial function of the copper-contained antibacterial fiber fabric is reduced gradually after frequent cleaning, thereby decreasing the antibacterial effect.

### BRIEF SUMMARY OF THE INVENTION

In accordance with the present invention, there is provided an antibacterial fabric comprising an antibacterial fabric body including multiple composite lines arranged longitudinally and multiple elastic fiber lines arranged latitudinally. The composite lines and the elastic fiber lines interweave longitudinally and latitudinally to form the antibacterial fabric body. The composite lines and the elastic fiber lines construct a weaving structure with stretching ductility and with determined elasticity and twist. Each of the composite lines includes multiple multi-filament polyester fiber yarns and at least one or more than one fiber copper alloy wire blending and intertwining with the multi-filament polyester fiber yarns to form antibacterial yarns. The at least one or more than one fiber copper alloy wire has a filament shape with a determined flexibility. The at least one or more than one fiber copper alloy wire is oxidized to steadily release copper ions which act in the multi-filament polyester fiber yarns, and each of the composite lines has a linear structure with an antibacterial function by action of the at least one or more than one fiber copper alloy wire.

In accordance with the present invention, there is further provided a method comprising:

a first step (a) including providing a determined amount of copper alloy staple in a melting furnace, adding a determined amount of metallic element in the melting furnace, and melting and kneading the copper alloy staple and the metallic element at a high temperature to form a copper alloy melting liquid, wherein the copper alloy staple contains an electrolytic copper with a high purity, and the metallic element has a high tensile strength, is erosion resistant and is wear resistant;

a second step (b) including filling the copper alloy melting liquid into a casting furnace to directly form a copper alloy embryo material by a casting process;

a third step (c) including stretching the copper alloy embryo material by multiple tensile working processes to form a fiber copper alloy wire, wherein, the fiber copper alloy wire has a filament shape with a determined flexibility after the multiple tensile working processes;

a fourth step (d) including blending and interweaving at least one or more than one fiber copper alloy wire with multiple multi-filament polyester fiber yarns by a determined proportion to form antibacterial yarns;

a fifth step (e) including intertwining the at least one or more than one fiber copper alloy wire in the multi-filament polyester fiber yarns tightly and closely to construct a composite line which contains the at least one or more than one fiber copper alloy wire and the multi-filament polyester fiber yarns, wherein the composite lines has determined elasticity and twist and has an antibacterial function; and

a sixth step (f) including interweaving multiple composite lines and multiple elastic fiber lines longitudinally and latitudinally to construct an antibacterial fabric body having determined elasticity and twist and having an antibacterial function.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective and locally enlarged view of a composite fiber antibacterial fabric in accordance with the preferred embodiment of the present invention.

FIG. 2 is a perspective cross-sectional view of the composite fiber antibacterial fabric in accordance with the preferred embodiment of the present invention.

FIG. 3 is a schematic plane view of the composite fiber antibacterial fabric in accordance with the preferred embodiment of the present invention.

FIG. 4 is a flow chart of a method for molding a composite fiber antibacterial fabric in accordance with the preferred embodiment of the present invention.

FIG. 5 is a schematic view showing a casting process of the method for molding a composite fiber antibacterial fabric in accordance with the preferred embodiment of the present invention.

FIG. 6 is a schematic view showing the composite fiber antibacterial fabric for one shoe.

FIG. 7 is a schematic view showing the composite fiber antibacterial fabric for an underwear.

FIG. 8 is a schematic view showing the composite fiber antibacterial fabric for a clothing.

FIG. 9 is a schematic view showing the composite fiber antibacterial fabric for a shoe insole.

FIG. 10 is a schematic view showing the composite fiber antibacterial fabric for one sock.

### DETAILED DESCRIPTION OF THE INVENTION

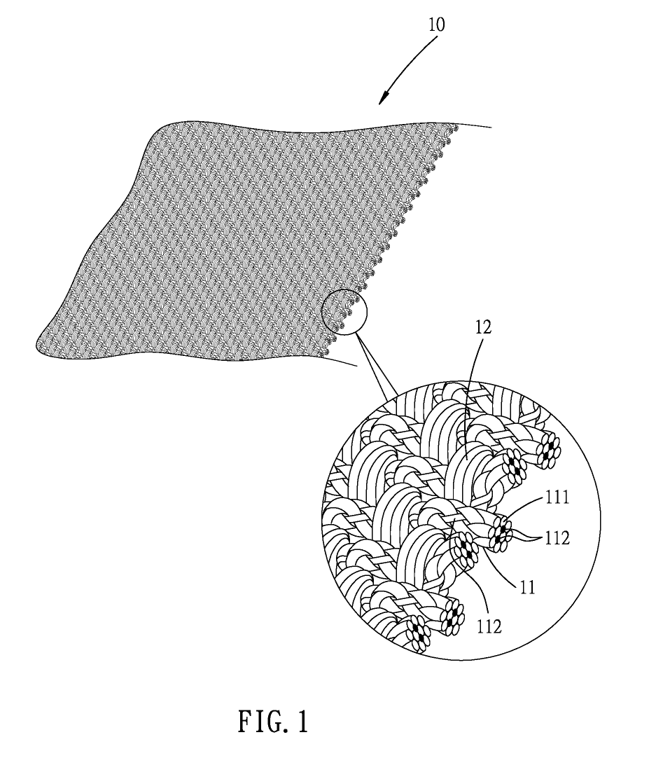

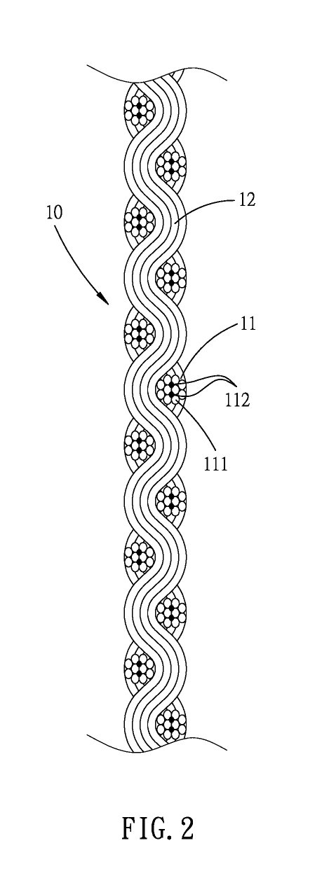

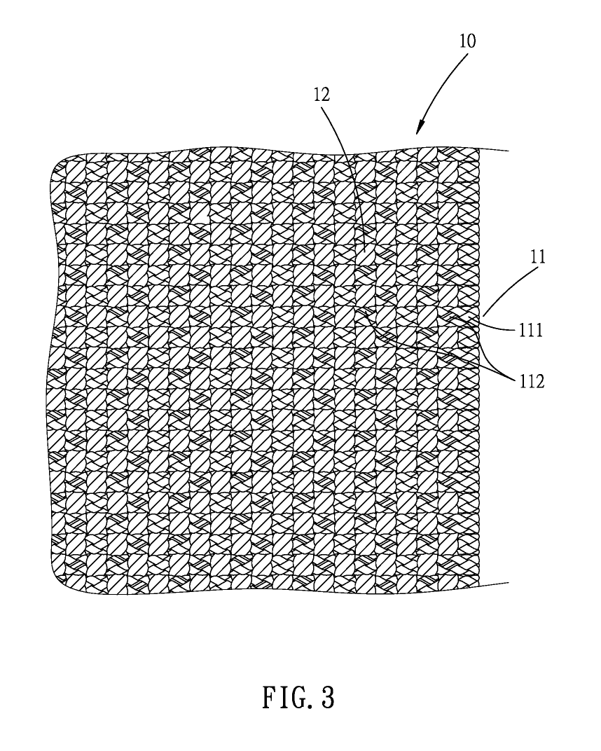

Referring to the drawings and initially to FIGS. 1-3, a composite fiber antibacterial fabric in accordance with the preferred embodiment of the present invention comprises an antibacterial fabric body 10 including multiple composite lines 11 arranged longitudinally and multiple elastic fiber lines 12 arranged latitudinally. The composite lines 11 and the elastic fiber lines 12 interweave longitudinally and latitudinally to form the antibacterial fabric body 10. The composite lines 11 and the elastic fiber lines 12 construct a weaving structure with stretching ductility and with determined elasticity and twist. Each of the composite lines 11 includes multiple multi-filament polyester fiber yarns 111 and at least one or more than one fiber copper alloy wire 112 blending and intertwining with the multi-filament polyester fiber yarns 111 to form antibacterial yarns. The at least one or more than one fiber copper alloy wire 112 has a filament shape with a determined flexibility. The at least one or more than one fiber copper alloy wire 112 is oxidized to steadily release copper ions which act in the multi-filament polyester fiber yarns 111, so that each of the composite lines 11 has a linear structure with an antibacterial function by action of the at least one or more than one fiber copper alloy wire 112.

In the preferred embodiment of the present invention, each of the multi-filament polyester fiber yarns 111 is made of flexible material. The at least one or more than one fiber copper alloy wire 112 is made of hard material. The at least one or more than one fiber copper alloy wire 112 is intertwined in the multi-filament polyester fiber yarns 111 tightly and closely to construct the composite lines 11.

In the preferred embodiment of the present invention, each of the multi-filament polyester fiber yarns 111 is made of plastic material.

In the preferred embodiment of the present invention, the multi-filament polyester fiber yarns 111 have a number more than that of the at least one or more than one fiber copper alloy wire 112.

In the preferred embodiment of the present invention, the multi-filament polyester fiber yarns 111 are made of cotton yarns, nylon, wool yarns, long fibers or short fibers. Alternatively, the multi-filament polyester fiber yarns 111 may be made of Mono nylon, Multi-Mono nylon, Polyethylene, Knotless or Dyneema.

In the preferred embodiment of the present invention, the at least one or more than one fiber copper alloy wire 112 is encompassed by the multi-filament polyester fiber yarns 111.

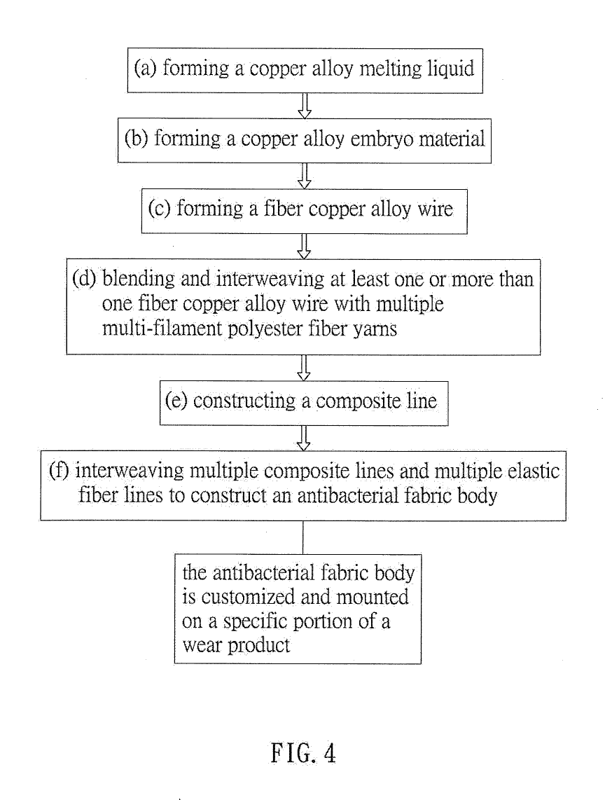

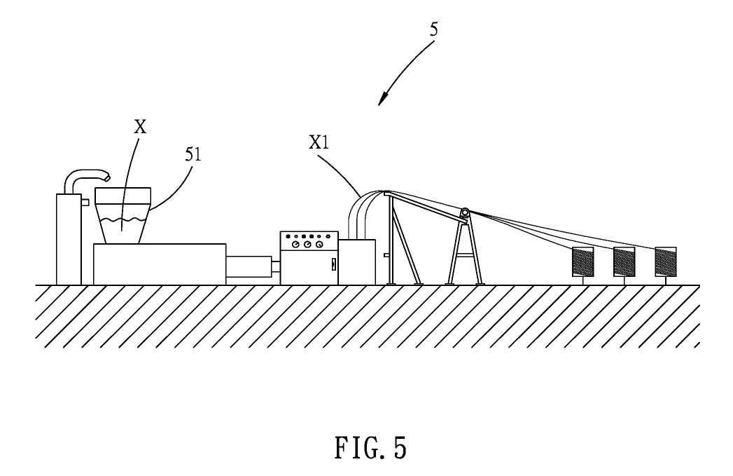

Referring to FIGS. 4 and 5 with reference to FIGS. 1-3, a method for molding an antibacterial fabric body 10 in accordance with the preferred embodiment of the present invention comprises a first step (a), a second step (b), a third step (c), a fourth step (d), a fifth step (e) and a sixth step (f).

The first step (a) includes providing a determined amount of copper alloy staple in a melting furnace, adding a determined amount of metallic element in the melting furnace, and melting and kneading the copper alloy staple and the metallic element at a high temperature to form a copper alloy melting liquid “X”. The copper alloy staple contains an electrolytic copper with a high purity. The metallic element has a high tensile strength, is erosion resistant and is wear resistant.

The second step (b) includes filling the copper alloy melting liquid “X” into a casting furnace 51 to directly form a copper alloy embryo material “Xl” by a casting process 5.

The third step (c) includes stretching the copper alloy embryo material “Xl” by multiple tensile working processes to form a fiber copper alloy wire 112. At this time, the fiber copper alloy wire 112 has a filament shape (having a nanometer size) with a determined flexibility after the multiple tensile working processes.

The fourth step (d) includes blending and interweaving at least one or more than one fiber copper alloy wire 112 with multiple multi-filament polyester fiber yarns 111 by a determined proportion to form antibacterial yarns. Each of the multi-filament polyester fiber yarns 111 is made of flexible material. The at least one or more than one fiber copper alloy wire 112 is made of hard material. The multi-filament polyester fiber yarns 111 have a number more than that of the at least one or more than one fiber copper alloy wire 112.

The fifth step (e) includes intertwining the at least one or more than one fiber copper alloy wire 112 in the multi-filament polyester fiber yarns 111 tightly and closely to construct a composite line 11 which contains the at least one or more than one fiber copper alloy wire 112 and the multi-filament polyester fiber yarns 111. The composite lines 11 has determined elasticity and twist and has an antibacterial function.

The sixth step (f) includes interweaving multiple composite lines 11 and multiple elastic fiber lines 12 longitudinally and latitudinally to construct an antibacterial fabric body 10 having determined elasticity and twist and having an antibacterial function.

In the preferred embodiment of the present invention, the antibacterial fabric body 10 is customized and mounted on a specific portion of a wear product, which is easily dirtied, sweated or produces smell.

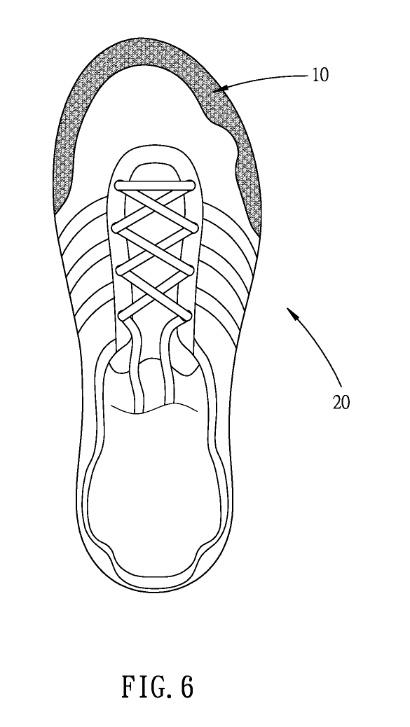

As shown in FIG. 6, the antibacterial fabric body 10 is customized and mounted on a toe portion of one shoe 20.

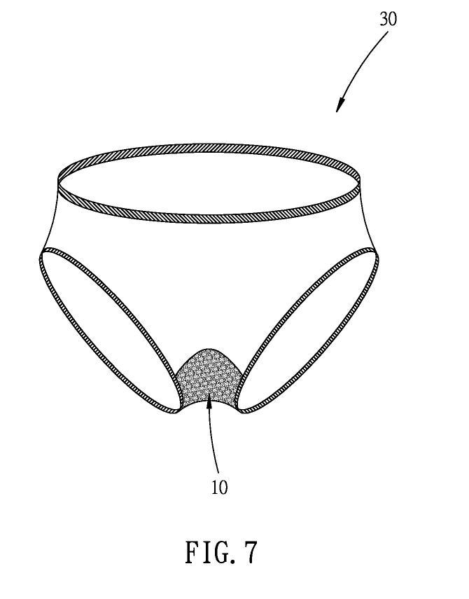

As shown in FIG. 7, the antibacterial fabric body 10 is customized and mounted on a crotch of an underwear 30.

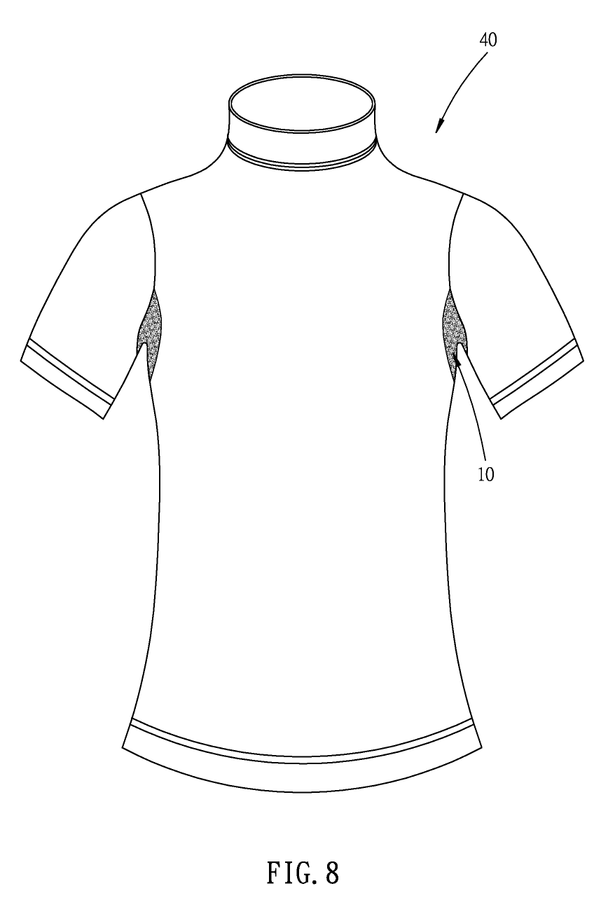

As shown in FIG. 8, the antibacterial fabric body 10 is customized and mounted on an armpit of a clothing 40.

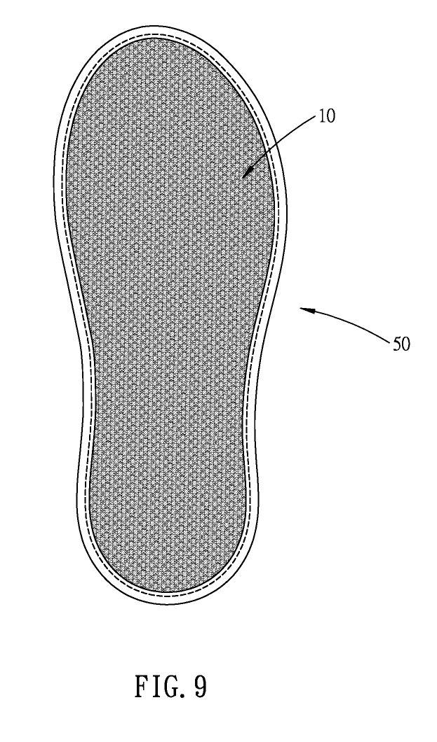

As shown in FIG. 9, the antibacterial fabric body 10 is customized and mounted on a shoe insole 50.

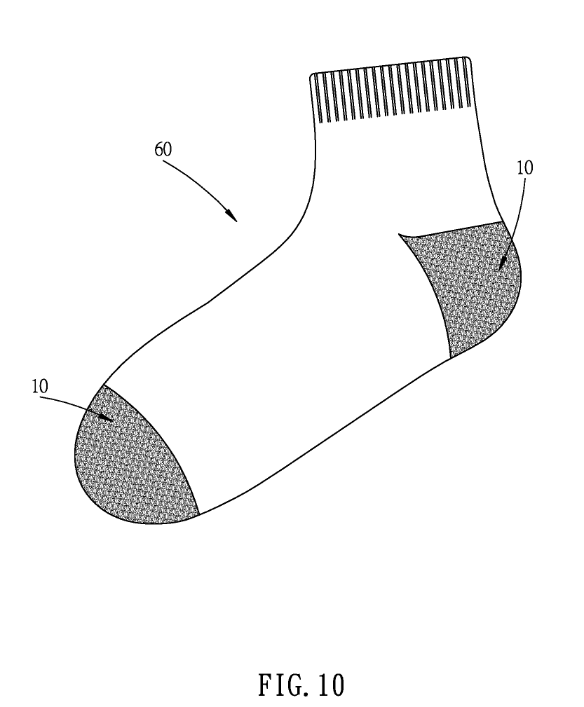

As shown in FIG. 10, the antibacterial fabric body 10 is customized and mounted on one sock 60.

In another preferred embodiment of the present invention, the antibacterial fabric body 10 is customized to form a bed sheet, a surgical clothing, a surgical cap, a glove, a mask, a towel, a pillowcase or the like.

Accordingly, the at least one or more than one fiber copper alloy wire 112 is oxidized to steadily release copper ions which act in the multi-filament polyester fiber yarns 111, so that the antibacterial fabric body 10 has a long-term antibacterial function by action of the at least one or more than one fiber copper alloy wire 112. In addition, the antibacterial fabric body 10 has a high tensile strength by provision of the at least one or more than one fiber copper alloy wire 112. Further, the composite lines 11 and the elastic fiber lines 12 construct a weaving structure with stretching ductility and with determined elasticity and twist, so that the antibacterial fabric body 10 has a better elasticity and ductility, thereby providing a comfortable sensation to the user.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An antibacterial fabric comprising:
an antibacterial fabric body including multiple composite lines arranged longitudinally and multiple elastic fiber lines arranged latitudinally;
wherein:
the composite lines and the elastic fiber lines interweave longitudinally and latitudinally to form the antibacterial fabric body;
the composite lines and the elastic fiber lines construct a weaving structure with stretching ductility and with determined elasticity and twist;
each of the composite lines includes multiple multi-filament polyester fiber yarns and at least one or more than one fiber copper alloy wire blending and intertwining with the multi-filament polyester fiber yarns to form antibacterial yarns;
the at least one or more than one fiber copper alloy wire has a filament shape with a determined flexibility;
the at least one or more than one fiber copper alloy wire is oxidized to steadily release copper ions which act in the multi-filament polyester fiber yarns; and
each of the composite lines has a linear structure with an antibacterial function by action of the at least one or more than one fiber copper alloy wire.

2. The antibacterial fabric of claim 1, wherein a method comprises:
a first step (a) including providing a determined amount of copper alloy staple in a melting furnace, adding a determined amount of metallic element in the melting furnace, and melting and kneading the copper alloy staple and the metallic element at a high temperature to form a copper alloy melting liquid, wherein the copper alloy staple contains an electrolytic copper with a high purity, and the metallic element has a high tensile strength, is erosion resistant and is wear resistant;
a second step (b) including filling the copper alloy melting liquid into a casting furnace to directly form a copper alloy embryo material by a casting process;
a third step (c) including stretching the copper alloy embryo material by multiple tensile working processes to form a fiber copper alloy wire, wherein, the fiber copper alloy wire has a filament shape with a determined flexibility after the multiple tensile working processes;
a fourth step (d) including blending and interweaving at least one or more than one fiber copper alloy wire with multiple multi-filament polyester fiber yarns by a determined proportion to form antibacterial yarns;
a fifth step (e) including intertwining the at least one or more than one fiber copper alloy wire in the multi-filament polyester fiber yarns tightly and closely to construct a composite line which contains the at least one or more than one fiber copper alloy wire and the multi-filament polyester fiber yarns, wherein the composite lines has determined elasticity and twist and has an antibacterial function; and
a sixth step (f) including interweaving multiple composite lines and multiple elastic fiber lines longitudinally and latitudinally to construct an antibacterial fabric body having determined elasticity and twist and having an antibacterial function.

3. The antibacterial fabric of claim 1, wherein the multi-filament polyester fiber yarns have a number more than that of the at least one or more than one fiber copper alloy wire.

4. The antibacterial fabric of claim 1, wherein the multi-filament polyester fiber yarns are made of cotton yarns, nylon, wool yarns, long fibers or short fibers.

5. The antibacterial fabric of claim 1, wherein the antibacterial fabric body is customized and mounted on a specific portion of a wear product, which is easily dirtied, sweated or produces smell.
